(19) United States
(12) Patent Application Publication
(10) Pub. No.: US 2014/0310500 A1
(43) Pub. Date: Oct. 16, 2014

(54) PAGE CROSS MISALIGN BUFFER

(71) Applicant: ADVANCED MICRO DEVICES, INC., Sunnyvale, CA (US)

(72) Inventors: David A. Kaplan, Austin, TX (US); Jeff Rupley, Round Rock, TX (US)

(73) Assignee: Advanced Micro Devices, Inc., Sunnyvale, CA (US)

(21) Appl. No.: 13/861,267

(22) Filed: Apr. 11, 2013

(51) Int. Cl. G06F 12/10

(52) U.S. Cl. CPC G06F 12/1009
USPC 711/206

(57) ABSTRACT

The present application describes embodiments of a method and apparatus including a page cross misalign buffer. Some embodiments of the apparatus include a store queue for a plurality of entries configured to store information associated with store instructions. A respective entry in the store queue can store a first portion of information associated with a page crossing store instruction. Some embodiments of the apparatus also include one or more buffers configured to store a second portion of information associated with the page crossing store instruction.

### BACKGROUND

This application relates generally to processing systems, and, more particularly, to a page cross misalign buffer for implementation in processing systems.

Processing systems utilize two basic memory access instructions: a store instruction that writes information from a register to a memory location and a load instruction that reads information out of a memory location and loads the information into a register. High-performance out-of-order execution microprocessors can execute load and store instructions out of program order. For example, a program code may include a series of memory access instructions including load instructions (L1, L2, . . . ) and store instructions (S1, S2, . . . ) that are to be executed in the order: S1, L1, S2, L2, . . . . However, the out-of-order processor may select the instructions in a different order such as L1, L2, S1, S2, . . . . Some instruction set architectures (e.g. the x86 instruction set architecture) require strong ordering of memory operations. Generally, memory operations are strongly ordered if they appear to have occurred in the program order specified. When attempting to execute instructions out of order, the processor must respect true dependencies between instructions because executing load instructions and store instructions out of order can produce incorrect results if a dependent load/store pair was executed out of order. For example, if (older) S1 stores data to the same physical address that (younger) L1 subsequently reads data from, the store S1 must be completed (or retired) before L1 is performed so that the correct data is stored at the physical address for L1 to read.

Store and load instructions typically operate on memory locations in one or more caches associated with the processor. Values from store instructions are not committed to the memory system (e.g., the caches) immediately after execution of the store instruction. Instead, the store instructions, including the memory address and store data, are buffered in a store queue so they can be written in-order. Eventually, the store commits and the buffered data is written to the memory system. Buffering store instructions can be used to help reorder store instructions so that they can commit in order. However, buffering store instructions can introduce other complications. For example, a load instruction can read an old, out-of-date value from a memory address if a store instruction executes and buffers data for the same memory address in the store queue and the load attempts to read the memory value before the store instruction has retired.

Store instructions may occasionally write information to memory locations that are partly in a first memory page and partly in a different (second) memory page. For example, some store instructions write portions of their data to two different cache lines. This type of store instruction is called a misaligned store instruction. A subset of misaligned store instructions write to cache lines that are present in different memory pages, e.g., as defined by a memory management unit in the system. These store instructions are called page crossing store instructions and the portion of the information that is stored on the second memory page may be referred to as misaligned information. Page crossing store instructions introduce extra complexity because each half of the store has a different physical address. Furthermore, the different memory pages may be implemented according to different caching policies. For example, the memory may be fully cache-able (e.g. a write-back (WB) cache policy), partly cache-able (e.g. write-through (WT) cache policy), or completely uncacheable (e.g. un-cacheable (UC) cache policy). Operations such as STLF, blocking, and general handling of the store instructions must account for the possibility that a store instruction is a page crossing store instruction, which may require additional logic and may impact critical path timing.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One technique for handling page crossing store instructions is to allocate two store queue entries for each page crossing store instruction. However, the logic for allocating and keeping track of multiple queue entries for a single page crossing store instruction can be complex. Another technique for handling page crossing store instructions is to extend each entry in the store queue to provide sufficient space for storing data and address information for the portions of the store instruction that are to be stored in the different memory pages. However, the extended queue entries require extra area on the die. During normal operation, the number of page crossing store instructions under typical workloads has been estimated to be a very small fraction of all store instructions. Consequently, these techniques are very expensive (e.g., in terms of die area, logic complexity, or timing limitations) relative to the potential performance gains. Nevertheless, page crossing store instructions occur frequently enough that they must be handled correctly by the system.

The disclosed subject matter is directed to addressing the effects of one or more of the problems set forth above.

In some embodiments, an apparatus is provided that includes a page cross misalign buffer. Some embodiments of the apparatus include a store queue for a plurality of entries configured to store information associated with store instructions. A respective entry in the store queue can store a first portion of information associated with a page crossing store instruction. Some embodiments of the apparatus also include one or more buffers configured to store a second portion of information associated with the page crossing store instruction.

In some embodiments, a method is provided for a page cross misalign buffer. Some embodiments of the method include storing a first portion of information associated with a store instruction in a store queue and determining whether the store instruction is a page crossing store instruction. Some embodiments of the method also include storing a second portion of a second portion of information associated with the store instruction in one or more buffers in response to determining that the store instruction is a page crossing store instruction.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates an example of a semiconductor device that may be formed in or on a semiconductor wafer (or die), according to some embodiments;

FIG. 2 conceptually illustrates examples of a store instruction and a page crossing store instruction, according to some embodiments;

FIG. 3 conceptually illustrates an example of a load store unit such as the load store unit shown in FIG. 1, according to some embodiments; and

FIG. 4 conceptually illustrates an example of a method for allocating entries in a store queue and a page cross misalign buffer to page crossing store instructions, according to some embodiments.

While the disclosed subject matter may be modified and may take alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION

Illustrative embodiments are described below. In the interest of clarity, not all features of an actual implementation are described in this specification. It should be appreciated that in the development of any such actual embodiment, numerous implementation-specific decisions should be made, which may vary from one implementation to another. Moreover, it should be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

As discussed herein, page crossing store instructions occur frequently enough that they must be handled correctly by the system but conventional techniques are very expensive (in terms of die area, logic complexity, or timing limitations) relative to the potential performance gains. The present application therefore describes embodiments of a store queue that implements one or more page cross misalign buffers that can be used to store information for misaligned portions of one or more store instructions. For example, a page cross misalign buffer can be used to store the physical address and memory type of a store instruction. Store instructions may then be checked to determine whether the store instruction is a page crossing store instruction when the store instruction receives its address and is picked or executed for the first time. Page crossing store instructions may have to wait in the store queue until a condition is met such as the page crossing store instruction becoming the oldest store instruction in the store queue or a page cross misalign buffer becoming available. A page crossing store instruction can then fill the page cross misalign buffer with information for the misaligned portion when the page crossing store instruction satisfies the conditions such as when the page crossing store instruction becomes the oldest store instruction in the store queue. Some embodiments of the page cross misalign buffer may be treated as another entry in the store queue and used for blocking, aliasing, STLF, and the like.

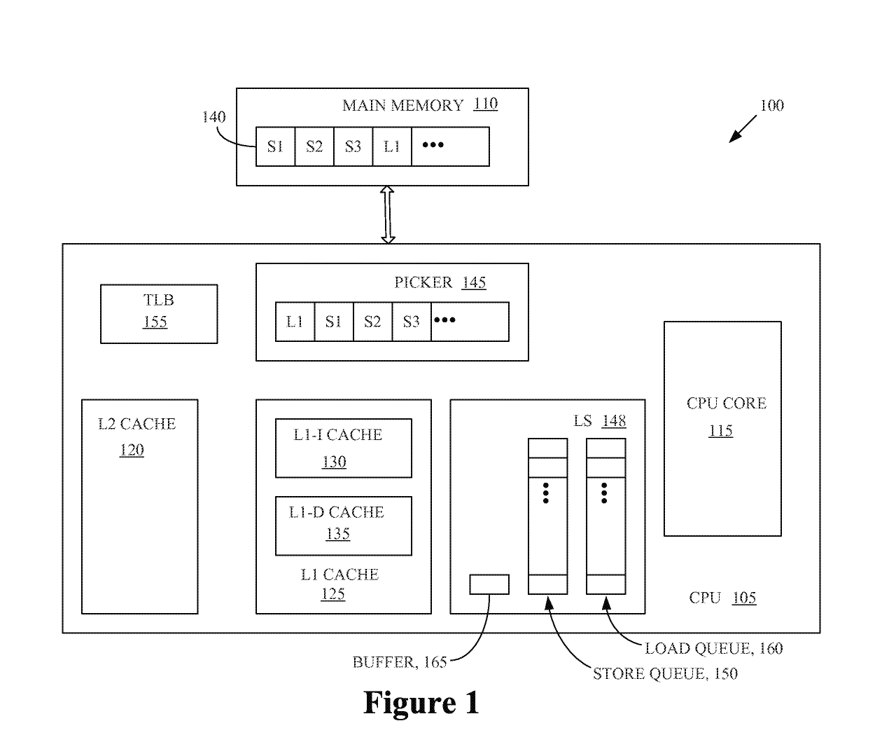

FIG. 1 conceptually illustrates an example of a semiconductor device 100 that may be formed in or on a semiconductor wafer (or die), according to some embodiments. The semiconductor device 100 may be formed in or on the semiconductor wafer using well known processes such as deposition, growth, photolithography, etching, planarizing, polishing, annealing, and the like. Some embodiments of the device 100 include a central processing unit (CPU) 105 that is configured to access instructions or data that are stored in the main memory 110. The CPU 105 includes a CPU core 115 that is used to execute the instructions or manipulate the data. The CPU 105 also implements a hierarchical (or multilevel) cache system that is used to speed access to the instructions or data by storing selected instructions or data in the caches. However, persons of ordinary skill in the art having benefit of the present disclosure should appreciate that some embodiments of the device 100 may implement different configurations of the CPU 105, such as configurations that use external caches. Some embodiments may implement different types of processors such as graphics processing units (GPUs) or accelerated processing units (APUs) and some embodiments may be implemented in processing devices that include multiple processing units or processor cores.

The cache system shown in FIG. 1 includes a level 2 (L2) cache 120 for storing copies of instructions or data that are stored in the main memory 110. Relative to the main memory 110, the L2 cache 120 may be implemented using faster memory elements and may have lower latency. The cache system shown in FIG. 1 also includes an L1 cache 125 for storing copies of instructions or data that are stored in the main memory 110 or the L2 cache 120. Relative to the L2 cache 120, the L1 cache 125 may be implemented using faster memory elements so that information stored in the lines of the L1 cache 125 can be retrieved quickly by the CPU 105. Some embodiments of the L1 cache 125 are separated into different level 1 (L1) caches for storing instructions and data, which are referred to as the L1-I cache 130 and the L1-D cache 135. Persons of ordinary skill in the art having benefit of the present disclosure should appreciate that the cache system shown in FIG. 1 is one example of a multi-level hierarchical cache memory system and some embodiments may use different multilevel caches including elements such as L0 caches, L1 caches, L2 caches, L3 caches, inclusive caches, and the like.

The CPU core 115 can execute programs that are formed using instructions such as load instructions and store instructions. Some embodiments of programs are stored in the main memory 110 and the instructions are kept in program order, which indicates the logical order for execution of the instructions so that the program operates correctly. For example, the main memory 110 may store instructions for a program 140 that includes the stores S1, S2, S3 and the load L1 in program order. Instructions that occur earlier in program order are referred to as “older” instructions and instructions that occur later in program order are referred to as “younger” instructions. Persons of ordinary skill in the art having benefit of the present disclosure should appreciate that the program 140 may also include other instructions that may be performed earlier or later in the program order of the program 140.

Some embodiments of the CPU 105 are out-of-order processors that can execute instructions in an order that differs from the program order of the instructions in the program 140. The instructions may therefore be decoded and dispatched in program order and then issued out-of-order. As used herein, the term “dispatch” refers to sending a decoded instruction to the appropriate unit for execution and the term “issue” refers to executing the instruction. The CPU 105 includes a picker 145 that is used to pick instructions for the program 140 to be executed by the CPU core 115. For example, the picker 145 may select instructions from the program 140 in the order L1, S1, S2, which differs from the program order of the program 140 because the younger load L1 is picked before the older stores S1, S2.

The CPU 105 implements a load-store unit (LS 148) that includes one or more store queues 150 that are used to store the store instructions and associated data. The data location for each store instruction is indicated by a linear address, which may be translated into a physical address so that data can be accessed from the main memory 110 or one of the caches 120, 125, 130, 135. The CPU 105 may therefore include a translation look aside buffer (TLB) 155 that is used to translate linear addresses into physical addresses. When a store instruction (such as S1 or S2) is picked and receives a valid address translation from the TLB 155, the store instruction may be placed in the store queue 150 to wait for data. Some embodiments of the store queue 150 may be divided into multiple portions/queues so that store instructions may live in one queue until they are picked and receive a TLB translation and then the store instructions can be moved to another (second) queue. The second queue may be the only one that stores data for the stores. Some embodiments of the store queue 150 may be implemented as one unified queue for store instructions so that each store instruction can receive data at any point (before or after the pick).

One or more load queues 160 are implemented in the load-store unit 148 shown in FIG. 1. Load data may be indicated by linear addresses and so the linear addresses for load data may be translated into a physical address by the TLB 155. A load instruction (such as L1) may be added to the load queue 160 when the load instruction is picked and receives a valid address translation from the TLB 155. The load instruction can use the physical address (or possibly the linear address) to check the store queue 150 for address matches. If an address (linear or physical depending on the embodiment) in the store queue 150 matches the address of the data used by the load instruction, STLF may be used to forward the data from the store queue 150 to the load instruction in the load queue 160.

The load-store unit 148 implements a buffer 165 that may be referred to as a page cross misalign buffer. The buffer 165 is configured to store information associated with a misaligned portion of a store instruction that has been dispatched and allocated an entry in the store queue 150. For example, entries in the store queue 150 may store information such as a physical address of a location at which the data is to be stored, a memory type of the memory page that is to store the data, the data that is to be stored, and the like. However, a page crossing store instruction stores portions of data at locations indicated by physical addresses in different memory pages. The buffer 165 may therefore be configured to store information such as a physical address of a location at which a misaligned portion of the data is to be stored, a memory type of the memory page that is to store the misaligned portion of the data, the misaligned portion of the data that is to be stored, and the like.

Some embodiments of the buffer 165 may be reserved for use by the oldest store instruction in the store queue 150. Store instructions that have been identified as page crossing store instructions may therefore have to wait in the store queue 150 until they become the oldest store instruction in the store queue 150. At that point, the misaligned portion of the store instruction can be written to the buffer 165 and the page crossing store instruction can be replayed and executed by the CPU core 115. Some embodiments of the load-store unit 148 may implement more than one buffer 165 for storing misaligned portions of more than one page crossing store instruction. In that case, other conditions may be used to determine when a page crossing store instruction is allowed to write the misaligned portion to one of the buffers 165. For example, available buffers 165 may be used by the oldest store instruction that has not already been allocated one of the buffers 165.

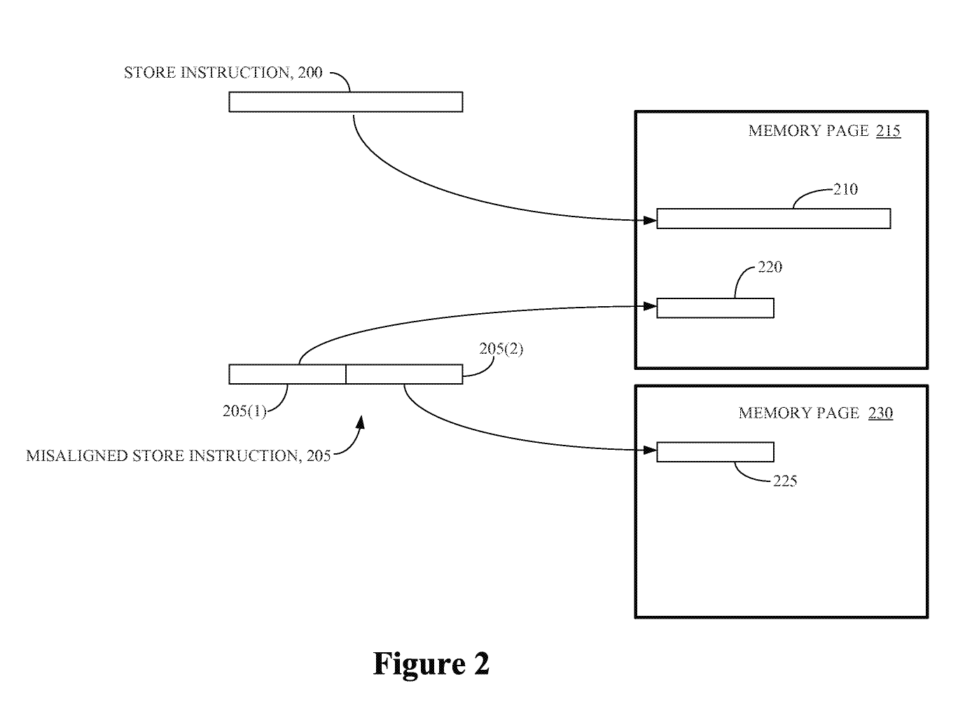

FIG. 2 conceptually illustrates examples of a store instruction 200 and a page crossing store instruction 205, according to some embodiments. The store instruction 200 is used to store information in a block 210 of memory elements within the memory page 215. As used herein, the term “memory page” refers to a fixed-length contiguous block of memory, which may be a block of virtual memory in some embodiments. A memory page may be the smallest unit of data for memory allocation or for transferring data between main memory and other storage devices. For example, memory pages in the x86 architecture are at least 4 kB of contiguous memory. The block 210 may be indicated by a physical address of a starting point within the memory page 215, a size of the block 210, a memory type of the memory page 215, or using any other technique or information to indicate the memory elements in the block 210. The page crossing store instruction 200 is used to store a first portion 205(1) of information in a block 220 in the memory page 215 and a second portion of information 205(2) in a block 225 in the memory page 230. The block 220 may be indicated by a physical address of a starting point within the memory page 215, a size of the block 220, a memory type of the memory page 215, or using any other technique or information to indicate the memory elements in the block 220. The block 225 may be indicated by a physical address of a starting point within the memory page 230, a size of the block 225, a memory type of the memory page 230, or using any other technique or information to indicate the memory elements in the block 225. As discussed herein, one of the portions 205 may be stored in a store queue such as the store queue 150 shown in FIG. 1 and another one of the portions 205 may be stored in a page cross misalign buffer such as the buffer 165 shown in FIG. 1.

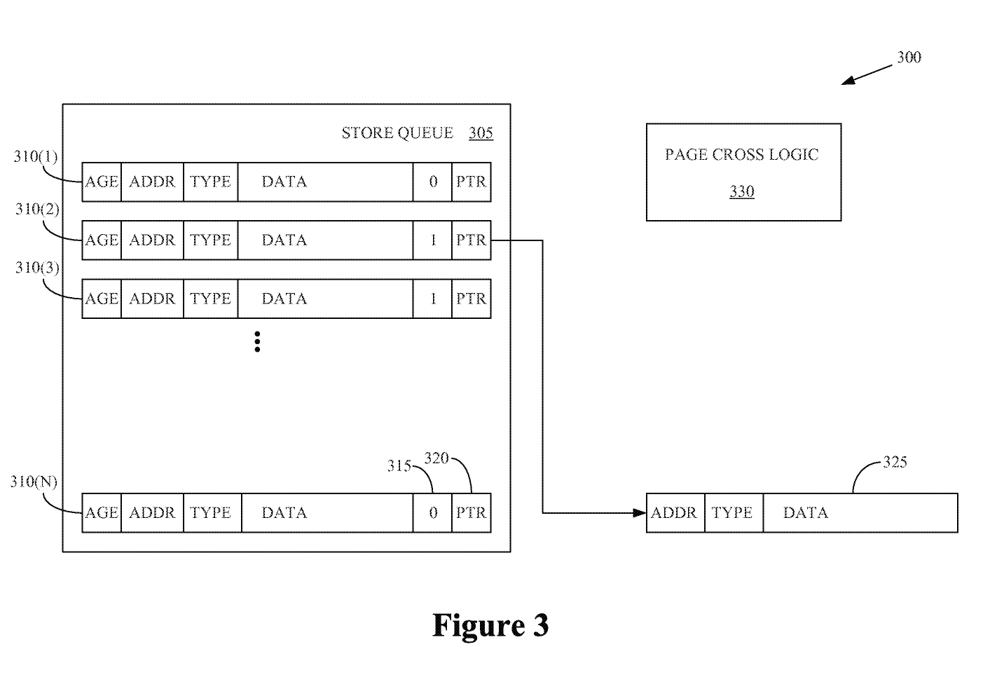

FIG. 3 conceptually illustrates an example of a load store unit 300 such as the load store unit 148 shown in FIG. 1, according to some embodiments. The load store unit 300 includes a store queue 305 for storing entries 310 associated with store instructions. Some embodiments of the entries 310 may be configured to store information (AGE) that indicates the relative age of the entries 310. For example, the AGE field may include a pointer that points to the next youngest or oldest entry 310. Other examples of the information in the AGE field may include timestamps or counters that indicate the relative ages of the entries 310. Some embodiments of the store queue 305 may store the entries 310 in an order that indicates their relative ages and so the AGE field may not be necessary in some embodiments. The entries 310 also include an address field (ADDR) that includes information indicating an address of a location for storing data associated with the store instruction, such as a physical address in a memory page. Some embodiments of the entries 310 may include information indicating a memory type (TYPE) of the memory page. The entries 310 also include space for storing data (DATA) that is to be stored at the address indicated in the address field upon execution of the corresponding store instruction.

Entries 310 in the store queue 305 include a bit 315 (only one indicated by a reference numeral in the interest of clarity) that can be set to indicate that the corresponding entry 310 is a page crossing store instruction. For example, the bit 315 in the entries 310(2-3) are set to a value of 1 to indicate that the store instructions associated with the entries 310(2-3) are page crossing instructions. Values of the other bits 315 in the other entries 310(1, 3-N) are set to 0 to indicate that these entries are not page crossing store instructions.

Entries in the store queue 305 also include a pointer (PTR) 320 (only one indicated by a reference numeral in the interest of clarity) that can be used to point to a page cross misalign buffer 325. The pointer 320 in the entry 310(2) points to the buffer 325 because the entry 310(2) is associated with the oldest store instruction in the store queue and is therefore eligible to use the buffer 325 for storing misalign portions, as discussed herein. Some embodiments of the store queue 305 may only define the pointer 320 for entries 310 associated with page crossing store instructions and some embodiments of the store queue 305 may define the pointer 320 for all entries 310 that are eligible to use the buffer 325 and then subsequently determine whether the corresponding store instruction is a page crossing store instruction that needs to use the buffer 325. Persons of ordinary skill in the art having benefit of the present disclosure should also appreciate that some embodiments may use other techniques or information for indicating associations of one or more entries 310 to one or more buffers 325.

The buffer 325 can then be used to store information associated with misaligned portions of the associated store instruction. For example, the buffer 325 may be used to store information indicating an address in another memory page that is different than the memory page indicated by the address in the entry 310(2). The buffer 325 may also be used to store information indicating the memory type of the memory page indicated by the address and data that is to be stored at the location in the memory page indicated by the address. Some embodiments of the buffer 325 may be treated in a manner that is analogous to the entry 310(2). For example, the load store unit 300 may treat the information in the buffer 325 as if it were another entry in the store queue 305 for the purposes of determining whether the page crossing store instruction is eligible for STLF, as well as for performing blocking or aliasing calculations.

The load store unit 300 also includes page cross logic 330. Some embodiments of the page cross logic 330 may be used to determine whether store instructions associated with one or more of the entries 310 are page crossing store instructions. The page cross logic 330 may keep track of the page crossing store instructions in the store queue 305 and may use information such as the AGE field to determine the oldest page crossing store instruction in the store queue 305. For example, the page cross logic 330 may determine whether the store instructions associated with one or more of the entries 310 cross a page boundary. Some embodiments of the page cross logic 330 may set the bit 315 associated with the store instructions that cross page boundaries to indicate that they are page crossing store instructions, e.g., the store instructions in the entries 310(2-3). The AGE field and the bit 315 may then be used to determine the oldest page crossing store instruction and to indicate that this store instruction is eligible to use the buffer 325 for storing misaligned portions of the store instruction. For example, the store instruction associated with the entry 310(2) may be determined to be the oldest page crossing store instruction. The page cross logic 330 may also be configured to define the pointer 320 that indicates the relationship between the buffer 325 and the entry 310(2) associated with the oldest page crossing store instruction.

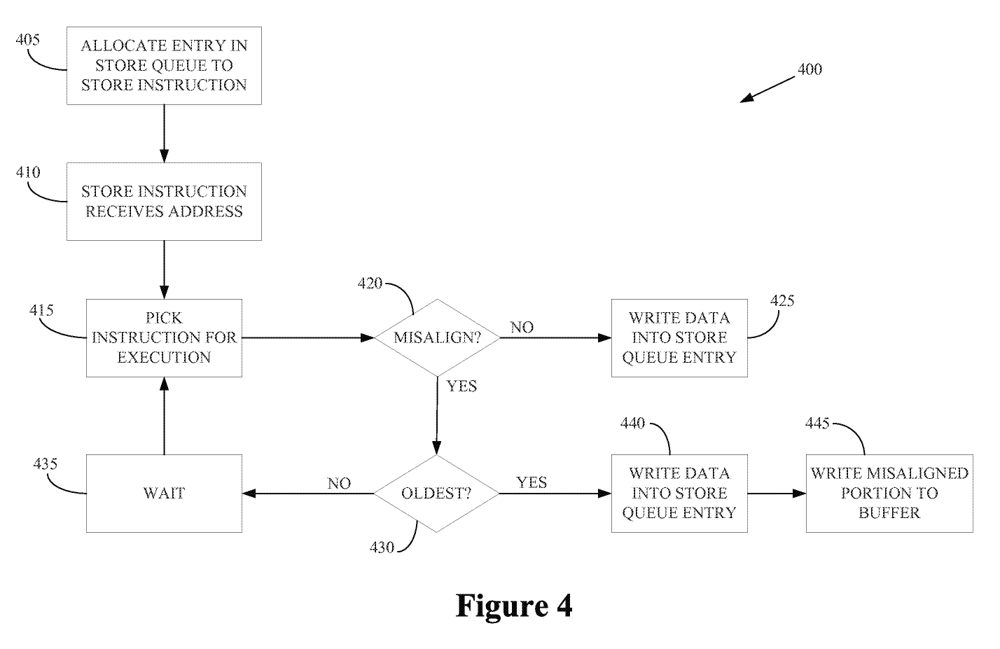

FIG. 4 conceptually illustrates an example of a method 400 for allocating entries in a store queue and a page cross misalign buffer to page crossing store instructions, according to some embodiments. The method 400 begins when a store instruction receives a virtual or physical address indicating one or more locations for storing data associated with the store instruction. The store instruction may then be dispatched to the store queue and allocated (at 405) an entry in the store queue. The store instruction may then receive (at 410) an address indicating where data is to be stored upon execution of the store instruction. Subsequently, the store instruction may be picked (at 415) for execution. Logic such as the page cross logic 330 shown in FIG. 3 may determine (at 420) whether the store instruction is a page crossing store instruction. Some embodiments of the logic may determine (at 420) whether the store instruction is a page crossing store instruction concurrently with one or more of the steps 405, 410, 415 or in response to performance of one or more of the steps 405, 410, 415.

The store instruction may be permitted to write (at 425) data into its corresponding store queue entry (e.g., from a translation lookaside buffer) if the store instruction is not a page crossing store instruction. The logic may determine (at 430) whether the store instruction is the oldest store instruction in the store queue when the logic determines (at 420) that the store instruction is a page crossing store instruction. The store instruction is not executed and waits (at 435) to be picked and replayed during a later cycle if it is not the oldest store instruction. If the page crossing store instruction is the oldest store instruction in the store queue, the store instruction is permitted to write (at 440) information associated with a first portion of the store instruction into a corresponding store queue entry, e.g., from a translation lookaside buffer. As discussed herein, the first portion of the store instruction may include information indicating a physical address in a memory page, a memory type of the memory page, data to be stored at a location indicated by the physical address, as well as other information.

The store instruction is also permitted to write (at 445) information associated with a misaligned portion of the store instruction to a page cross misalign buffer. For example, information indicating a physical address of the location used to store a misaligned portion of the data in another memory page, a memory type of the other memory page, and data to be stored at the location indicated by the physical address may be written (at 445) to the buffer. Some embodiments may also allocate a pointer in the store queue entry associated with the page crossing store instruction to indicate the relationship between the store queue entry and the buffer, as discussed herein.

Embodiments of the page cross misalign buffer described herein may have a number of advantages over the conventional practice. For example, implementing one or more page cross misalign buffers for storing misaligned portions of a subset of the store instructions in a store queue saves area over previous designs because only a subset (and in some embodiments only one) of the entries in the store queue is associated with a buffer for storing misaligned information. Some embodiments described herein also limit execution of page crossing store instructions to the oldest store instruction in the store queue so that the page crossing store instructions can be executed non-speculatively, thereby guaranteeing that execution of the page crossing store instruction advances the program. The number of corner cases that are needed to verify correct operation may therefore be reduced. Moreover, since page crossing store instructions are very rare under typical workloads, the performance impact of serializing the store instructions is negligible.

Embodiments of processor systems that can implement embodiments of page cross misalign buffers as described herein (such as the processor system 100) can be fabricated in semiconductor fabrication facilities according to various processor designs. In one embodiment, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

Furthermore, the methods disclosed herein may be governed by instructions that are stored in a non-transitory computer readable storage medium and that are executed by at least one processor of a computer system. Each of the operations of the methods may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. An apparatus, comprising:
a store queue comprising a plurality of entries configured to store information associated with store instructions, wherein a respective entry is configured to store a first portion of information associated with a page crossing store instruction; and
at least one buffer configured to store a second portion of information associated with the page crossing store instruction.

2. The apparatus of claim 1, wherein the page crossing store instruction, when executed, writes first data to a first memory page and second data to a second memory page.

3. The apparatus of claim 2, wherein an entry in the store queue storing the first portion of information associated with the page crossing instruction comprises information indicating a first physical address in the first memory page and said at least one buffer storing the second portion of information associated with the page crossing instruction comprises information indicating a second physical address in the second memory page.

4. The apparatus of claim 3, wherein the entry storing the first portion of information associated with the page crossing store instruction comprises information indicating that the entry stores a page crossing store instruction.

5. The apparatus of claim 4, wherein the entry storing the first portion of information associated with the page crossing store instruction comprises information associating the entry with said at least one buffer.

6. The apparatus of claim 1, comprising logic configured to determine whether store instructions are page crossing store instructions.

7. The apparatus of claim 6, wherein said logic is configured to determine whether at least one page crossing store instruction is eligible to use said at least one buffer to store information associated with the second portion of the page crossing store instruction.

8. The apparatus of claim 7, wherein said logic is configured to determine whether said at least one page crossing store instruction is an oldest store instruction in the store queue.

9. A method, comprising:
storing a first portion of information associated with a store instruction in a store queue; and
storing a second portion of a second portion of information associated with the store instruction in at least one buffer when the store instruction is a page crossing store instruction.

10. The method of claim 9, wherein the page crossing store instruction, when executed, writes first data to a first memory page and second data to a second memory page.

11. The method of claim 10, wherein storing the first portion of information associated with the page crossing instruction comprises storing information indicating a first physical address in the first memory page, and wherein storing the second portion of information associated with the page crossing instruction comprises storing information indicating a second physical address in the second memory page.

12. The method of claim 11, wherein storing the first portion of information associated with the page crossing store instruction comprises storing information indicating that the entry stores a page crossing store instruction.

13. The method of claim 12, wherein storing the first portion of information associated with the page crossing store instruction comprises storing information associating the entry with said at least one buffer.

14. The method of claim 13, comprising determining whether the page crossing store instruction is eligible to use said at least one buffer to store information associated with the second portion of the page crossing store instruction.

15. The method of claim 14, wherein determining whether the page crossing store instruction is eligible to use said at least one buffer comprises determining that the page crossing store instruction is eligible to use said at least one buffer in response to determining that the page crossing store instruction is the oldest store instruction in the store queue.

16. The method of claim 15, wherein determining whether the page crossing store instruction is eligible to use said at least one buffer comprises replaying the page crossing store instruction in response to determining that the page crossing store instruction is not the oldest store instruction in the store queue.

17. A non-transitory computer readable media including instructions that when executed can configure a manufacturing process used to manufacture a semiconductor device comprising:
a store queue comprising a plurality of entries configured to store information associated with store instructions, wherein a respective entry is configured to store a first portion of information associated with a page crossing store instruction; and
at least one buffer configured to store a second portion of information associated with the page crossing store instruction.

18. The non-transitory computer readable media set forth in claim 17, further comprising instructions that when executed can configure the manufacturing process used in manufacturing the semiconductor device comprising logic configured to determine whether store instructions are page crossing store instructions.
